(19) United States
(12) Patent Application Publication
(10) Pub. No.: US 2023/0191679 A1
(43) Pub. Date: Jun. 22, 2023

(54) PROCESS FOR MANUFACTURING A BUILDING PANEL AND AN ASSOCIATED BUILDING PANEL

(71) Applicant: Ceraloc Innovation AB, Viken (SE)

(72) Inventors: Filip SKÖLD, Löddeköpinge (SE); Pontus GAMSTEDT, Kattarp (SE); Per JOSEFSSON, Ramlösa (SE)

(73) Assignee: Ceraloc Innovation AB, Viken (SE)

(21) Appl. No.: 18/067,184

(22) Filed: Dec. 16, 2022

(30) Foreign Application Priority Data
Dec. 20, 2021 (SE) 21515580

(51) Int. Cl. B29C 48/00; B29C 48/08; B32B 5/20; B32B 27/20; B32B 27/06

(52) U.S. Cl. CPC B29C 48/0012; B29C 48/002; B29C 48/08; B32B 5/20; B32B 27/20; B32B 27/065; B29K 2027/06

(57) ABSTRACT

The disclosure relates to a process for manufacturing a building panel, such as a floor panel, including a core. The process includes providing a core material including a thermoplastic material, a filler and hollow microparticles, and applying heat and pressure to the core material to form the core. The disclosure also relates to a corresponding building panel.

### CROSS REFERENCE TO RELATED APPLICATIONS

The present application claims the benefit of Swedish Application No. SE 2151558-0, filed on Dec. 20, 2021. The entire contents of Swedish Application No. SE 2151558-0 are hereby incorporated herein by reference in their entirety.

### TECHNICAL FIELD

The disclosure generally relates to a process for manufacturing a building panel, such as a floor panel. More specifically, the building panel to be manufactured may comprise a core comprising a thermoplastic material or a thermosetting resin, a filler and hollow microparticles. The disclosure also relates to a corresponding building panel, such as a floor panel.

### BACKGROUND

Building components comprising thermoplastic-based panels offer a variety of advantages. In the case of, say, floor coverings, each panel may be a Luxury Vinyl Tile (LVT tile), a Stone Plastic (Polymer) Composite panel or Solid Polymer Core panel (SPC panel), or an Expanded Polymer Core panel (EPC panel), also known as Water Proof Core panel or Wood Plastic Composite panel (WPC panel). The panels may be selected depending on the desired characteristics and applications of the covering: for example, LVT panels may provide flexibility while SPC, EPC and WPC panels may provide at least some degree of rigidity.

Some of the panels, especially SPC boards, typically have a high density and may therefore become very heavy, which may negatively impact their performance and/or handling. Additionally, the transportation costs of the boards and the associated environmental impact may sometimes become unreasonably high.

There have been various attempts to reduce the weight of building boards. WO 2013/032391 and WO 2014/007738 disclose panels, such as floor panels, comprising a thermoplastic material and being provided with a certain groove structure in their rear sides, which may significantly reduce the weight of the panels. Moreover, as disclosed in, e.g., WO 2021/031289, the density of an SPC floor may be reduced by means of a chemically or physically foamed layer. A drawback of a foamed layer, however, is that it may lose some of its mechanical properties, such as its dimensional stability, under an exposure of temperature variations. Additionally, a foamed layer may be susceptible to damage under an applied external pressure.

### SUMMARY

It is therefore an object of at least certain embodiments of the present disclosure to provide a process for manufacturing a building panel, such as a floor panel, having a reduced weight and/or density, preferably while maintaining or even improving its climate properties, such as under variations in temperature, and/or its mechanical properties, such as bending strength and/or bending strain.

It is also an object of at least certain embodiments of the present disclosure to provide a related building panel. Additionally, it is an object of at least certain embodiments of the present disclosure to provide a building panel having improved acoustic properties and/or increased heat insulation.

Yet another object of at least certain embodiments of the present disclosure is to provide a building panel which is easier to handle, such as during its installation.

These and other objects and advantages that will be apparent from the description have been achieved by the various aspects, embodiments and examples described below.

In accordance with a first aspect of the disclosure, there is provided a process for manufacturing a building panel, such as a floor panel, comprising a core. The process comprises providing a core material comprising a thermoplastic material, a filler and hollow microparticles, applying heat and pressure to the core material to form the core, and, optionally, applying a top layer, such as a print layer and/or a wear layer, to the core.

The hollow microparticles may function as a lightweight filler. Additionally, they may provide improved acoustic properties and/or an increased heat insulation of the core material and, hence, the core and/or building panel, often abbreviated “panel” herein.

By means of the hollow microparticles, which may have a lower density compared to a conventional filler, such as a mineral filler or wood fibres, a weight and/or density of the core, and hence the panel, may be reduced. For a given volume of the core comprising an inorganic filler, the weight of the core and/or panel may be reduced by at least 3%, such as 3-70%, preferably at least 5%, such as 5-50%. Thereby, the panel may be easier to transport and/or handle. In addition, the transportation costs of a large collection of such panels may be reduced, since the weight of such a collection may be significantly reduced.

The microparticles may substantially maintain their shape under relatively high temperatures, preferably at least up to 80° C. Thereby, e.g., as compared to a known panel, the climate properties of the panel may be maintained or even improved. Additionally, a packing density of the microparticles, especially for essentially spherical particles, may be higher than for more bulky fillers, whereby the core material may be able to achieve a higher strain at break. Thereby, some mechanical properties, such as a bending strength and/or bending strain, of the panel may be maintained or even improved. Likewise, a higher flexural strength may be provided.

By means of certain embodiments of the first aspect, the manufacturing of a core may become more versatile, e.g., in comparison with the manufacturing of a foamed core, such as an EPC panel, which may require the utilization of a foaming (blowing) agent. In preferred embodiments described herein, the core is not foamed. For example, a thin panel suitable for use as a building panel, such as a floor panel, preferably having a thickness of less than 5 mm, such as 2-5 mm, may be obtained. This may make the panel lighter and/or the volume of the panel smaller.

The microparticles may be separate, preferably non-expandable, particles. In preferred embodiments, the microparticles may be closed, such that their interior is sealed from their exterior. For example, more than 70% or more than 80% or even all (100%) of the, preferably total number of, microparticles in the core material and/or core may be closed.

Indeed, in some embodiments, a part of the microparticles in the core material may break under the application of heat and pressure, whereby their seal may break and their densities effectively increase. For example, 1-30% of the total number of microparticles may break, such as 1-20%. Nevertheless, the remaining sealed microparticles may provide a sufficient weight and/or density reduction of the panel.

Each microparticle may have an extension in three perpendicular directions. One of the directions may extend along a maximal thickness direction of the microparticle and/or a thickness direction of the panel. Each microparticle may have an extension of 5-200 μm, such as 10-100 μm, preferably 10-30 μm, in at least one direction of the microparticle, e.g., in said maximal thickness direction and/or panel thickness direction, and optionally in one or two additional directions perpendicular to the maximal thickness direction and/or panel thickness direction. For example, a difference in thickness along the maximal thickness direction between the 10^{th} and the 90^{th} percentile may be less than 150 μm, preferably less than 100 μm.

Generally herein, a density of the microparticles may be 100-1000 kg/m³, such as 200-800 kg/m³ or 300-500 kg/m³. A lower density may provide a lighter panel.

Preferably, the microparticles are non-porous. However, in some embodiments they may be porous.

The microparticles may encapsulate a gas. In other words, their interior may be filled with a gas. The gas may be air, nitrogen, or an inert gas.

The microparticles may be microspheres, such as hollow glass microspheres (glass bubbles). Thereby, the microparticles may be substantially spherical. The microspheres may have a diameter of 5-200 μm, such as 10-100 μm, preferably 10-30 μm. For example, a difference in diameter between the 10^{th} and the 90^{th} percentile may be less than 150 μm, preferably less than 100 μm.

Other shapes of the microparticles are equally conceivable. For example, they may be irregularly shaped or ovoid.

The microparticles, such as glass bubbles, may be, or may comprise, at least one compound selected from the group of silicon dioxide, aluminum oxide, sodalime, borosilicate, sodalime-borosilicate, and zirconia. For example, the microparticles may be, or may comprise, cenospheres, expanded perlite or ceramic microbubbles.

In some embodiments, the microspheres may be hollow polymer spheres, for example comprising polyethylene, PE, polymethyl methacrylate, PMMA, polypropylene, PP, or polystyrene, PS.

A crushing strength of the microparticles may exceed 14 MPa, such as being 14-210 MPa or 28-140 MPa. In some embodiments, the crushing strength may be 70-125 MPa. Preferably, the crushing strength exceeds or is limited by any of the above bounds in said three perpendicular directions. By having such a high crushing strength, the microparticles may become more resistant against external forces and may thereby be suitable for a tougher manufacturing process, such as an (co-)extrusion process or a general pressing process, while reducing or even avoiding their risk of breaking. Throughout the disclosure, “(co-)extrusion” means either extrusion or coextrusion in an extruder or a co-extruder, respectively, any of which is shortened as “(co-)extruder” herein. Generally herein, the crushing strength may be determined in accordance with ASTM D3102-78. Preferably, the crushing strength is determined at a 90% survival rate.

The thermoplastic material may comprise polyvinyl chloride, PVC. In some embodiments, the thermoplastic material may comprise PE, PP, thermoplastic polyurethane, TPU, or polyethylene terephthalate, PET.

Generally herein, the thermoplastic material may further comprise a plasticizer and/or at least one additive selected from the group of a stabilizer, a lubricant, an impact modifier, and a processing aid. Optionally, a coupling agent may be provided in the core material when polar microparticles are provided in non-polar polymer resins, such as PP or PE. For example, the coupling agent may comprise maleic anhydride or a silane coupling agent.

The filler may comprise, or may be, an inorganic filler, such as a mineral material, for example calcium carbonate (CaCO₃), limestone, such as chalk, talc or a stone material, such as stone powder or rock flour. Thereby, the core and/or panel may become better reinforced and its/their mechanical properties may thereby be improved. Also, the core may become cheaper to manufacture. A mean particle size of the filler, preferably the D50 particle size, may be 8-25 μm, preferably 10-20 μm.

The filler may comprise, or may be, an organic filler, such as a wood material, a bamboo material or rice husks. For example, the wood material may be wood fibres and/or wood dust, and the bamboo material may be bamboo dust. Thereby, a panel having an organic lightweight filler may be manufactured.

In some embodiments, a degree of, preferably inorganic or organic, filler, preferably in the core, may not exceed 70 vol %, preferably being 10-60 vol % or 40-60 vol %. For example, this may provide a rigid core, especially for an inorganic filler.

In some embodiments, a degree of microparticles, preferably in the core, may be 3-50 vol %, such as 5-40 vol % or 10-30 vol %.

A degree of plasticizer in the core material and/or core may be less than 5 wt %, preferably less than 3 wt % or less than 1 wt %, and may be in the range of 0.1-5 wt %, 0.5-5 wt %, or 0.5-3 wt %. This may be preferred in a rigid core. In some embodiments, there is no plasticizer in the core material and/or core.

In non-limiting examples, a modulus of elasticity, or Young's modulus E, of the formed core may generally herein be 300-12 000 MPa, preferably 500-10 000 MPa. A rigid core may have an E module exceeding 2000 MPa. The E module herein may be tested in accordance with ISO 178:2010.

The filler and microparticles may be substantially homogeneously distributed in the thermoplastic material. For example, these components may be mixed, e.g., in a mixer or in a (co-)extruder. Thereby, the filler and microparticles may become substantially homogeneously distributed in the core. Consequently, the core may obtain substantially the same mechanical properties throughout the board.

The process may further comprise laminating the top layer, such as the print layer and/or the wear layer, to the core. The lamination may comprise attaching the top layer to the formed core under pressure and, optionally, heat. The top layer may be attached to the core without using an adhesive. In particular, the top layer and the core may fuse together. The lamination may be performed in an in-line process after forming the core.

It is emphasized that, by means of the first aspect, lamination of a top layer is made possible for a broad class of cores. The robustness of the core may be maintained. At the same time, the density and/or weight of the core or panel may be kept low. This is to be compared with a top layer to be arranged on a foamed core, e.g., obtained by utilizing foaming agents. Indeed, the top layer typically needs to be attached to the foamed core by means of an adhesive for avoiding deterioration of at least some of the core properties. Indeed, excessive pressure and/or heat applied to a foamed core might damage the foaming of the core.

The concept of “applying heat and pressure” is broadly defined herein and includes an (co-)extrusion process, and a general pressing process, e.g., using a double-belt press or a static press, for example, comprising a press plate. In particular, the application of heat and pressure may comprise (co-)extruding the core material for forming a, preferably continuous, sheet. The co-extruded core material may form a coextruded sheet assembly. The core may be formed from the sheet or sheet assembly, e.g., by dividing it into an appropriate size. The divided sheet assembly may comprise the core and an upper and/or lower layer.

In some embodiments, at least a part of the microparticles, such as all of them, may be added to the (co-)extruder downstream of an inlet of the (co-)extruder. As a consequence, the microparticles may be less exposed to shear forces during the extrusion process, for example arising from a screw configuration of the extruder. In some embodiments, microparticles of lower quality and/or grade may be thereby used, e.g., as compared to if all of them would be added upstream of the (co-)extruder.

The process, preferably the act of applying heat and pressure, may further comprise calendaring the sheet or sheet assembly, such as directly after (co-)extruding the core material.

The core may be formed in a double-belt press. The core material may be pressed under heat in the double-belt press for forming a, preferably continuous, sheet. The core may be formed from the sheet, e.g., by dividing the sheet into an appropriate size.

The building panel may comprise a single layer in the form of the core, and optionally a top layer. Preferably, such a core is rigid and/or the climate influences, such as influences from temperature variations, of the core are negligible. For such a panel, a balancing layer may not be necessary, although it is not excluded.

Optionally, the process may further comprise attaching, such as laminating, an upper and/or a lower layer to the core. For example, a lower layer may be a balancing layer. Thereby, a balancing of the panel may become improved.

The process may further comprise forming at least one groove, such as cavity, by removing material from a rear side of the building panel and/or the core. Alternatively, at least one groove, such as cavity, may be formed by impressing the rear side. Thereby, the weight of the panel may be further reduced.

Generally herein, the process of the first aspect may be used for manufacturing a board element that may be a panel per se, or may be dividable into a panel. Alternatively, the board element may be a core per se of a panel, or it may be a sheet (sheet assembly) dividable into a core (a core comprising an upper and/or a lower layer) of a panel. Here and throughout the disclosure, it is clear that the panel is a building panel, such as a floor panel.

The process may further comprise dividing a board element formed from the application of heat and pressure to the core material into the building panel or the core. Indeed, the formed board element may have to be divided into a size that is adapted for use as a building panel or as a core in a building panel. For example, the board element may be the, preferably continuous, sheet (sheet assembly) formed by (co-)extrusion or by the double-belt press, optionally comprising a top layer. It is stressed that herein the concept of “dividing” optionally includes trimming of the board element, such as by knives.

In accordance with a second aspect of the disclosure, there is provided a building panel obtainable in accordance with any of the embodiments of the first aspect. Embodiments and examples of the second aspect are largely analogous to those of the first aspect, whereby reference is made thereto.

In accordance with a third aspect of the disclosure, there is provided a building panel comprising a core comprising a thermoplastic material, a filler and hollow microparticles.

Optionally, the building panel may comprise a top layer, such as a print layer and/or a wear layer, applied to the core. In some embodiments, the top layer comprises a, preferably digital, print directly printed on the core and optionally a wear layer provided thereon.

Embodiments and examples of the third aspect are largely analogous to those of the first and second aspects, whereby reference is made thereto.

In accordance with a fourth aspect of the disclosure, the thermoplastic material in the core material in accordance with the first, second or third aspect, is replaced by a thermosetting resin, preferably comprising polyurethane, PU, an epoxy resin, or a melamine-formaldehyde resin. Preferably, the core material comprises a filler, such as an inorganic and/or organic filler. Embodiments of the filler, such as their materials, degrees, etc., may be similar to the embodiments described herein in relation to filler in the thermoplastic material, whereby reference is made thereto.

Further aspects of the disclosure and embodiments and examples of the first, second, third and fourth aspects are provided in an embodiment section below which includes a list of items (clauses). It is emphasized that the embodiments and examples of the various aspects may be combined with each other.

Aspects of the disclosure have mainly been described above with reference to a few embodiments. However, as is readily appreciated by a person skilled in the art, other embodiments than the ones disclosed above are equally possible within the scope of aspects of the disclosure.

Generally, all terms used in the claims and in the items in the embodiment section below are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. Reference to one or a plurality of “at least one element,” etc., may shortly be referred to as “the element(s).”

### BRIEF DESCRIPTION OF THE DRAWINGS

The disclosure will in the following be described in connection to exemplary embodiments and in greater detail with reference to the appended exemplary drawings, wherein:

FIGS. 1a-1b, 2a illustrate in side views embodiments of an arrangement capable of implementing a process for manufacturing a board element, such as a building panel or a core thereof.

FIG. 2b illustrates in a side view an embodiment of a layer unit configured to attach an upper and/or a lower layer to the board element.

FIGS. 2c-2d illustrate in side views embodiments of a processing device for forming grooves (FIG. 2c) and of an annealing unit (FIG. 2d), which may be provided in the arrangement in any of FIGS. 1a-1b and 2a.

FIG. 2e illustrates in a perspective view an embodiment of a granule or a pellet.

FIGS. 3a-3e illustrate in cross-sectional side views embodiments of a building panel or a section of a board element, such as comprising a sheet or sheet assembly.

FIGS. 3f-3h illustrate in a cross-sectional side view (FIG. 3f) an embodiment of a core and in perspective views (FIGS. 3g-3h) embodiments of a hollow microparticle.

FIGS. 4a-4c illustrate an embodiment of a building panel in cross-sectional side views (FIGS. 4a-4b) and a bottom view (FIG. 4c).

FIGS. 4d-4f illustrate an embodiment of a building panel in a bottom view (FIG. 4d) and cross-sectional side views (FIGS. 4e-4f).

FIG. 5a is a flow chart illustrating embodiments of a process for manufacturing a building panel.

FIGS. 5b-5c illustrate in cross-sectional side views embodiments of a building panel or a section of a board element.

FIG. 5d illustrates in a bottom view an embodiment of a building panel comprising impressed grooves, such as cavities.

### DETAILED DESCRIPTION

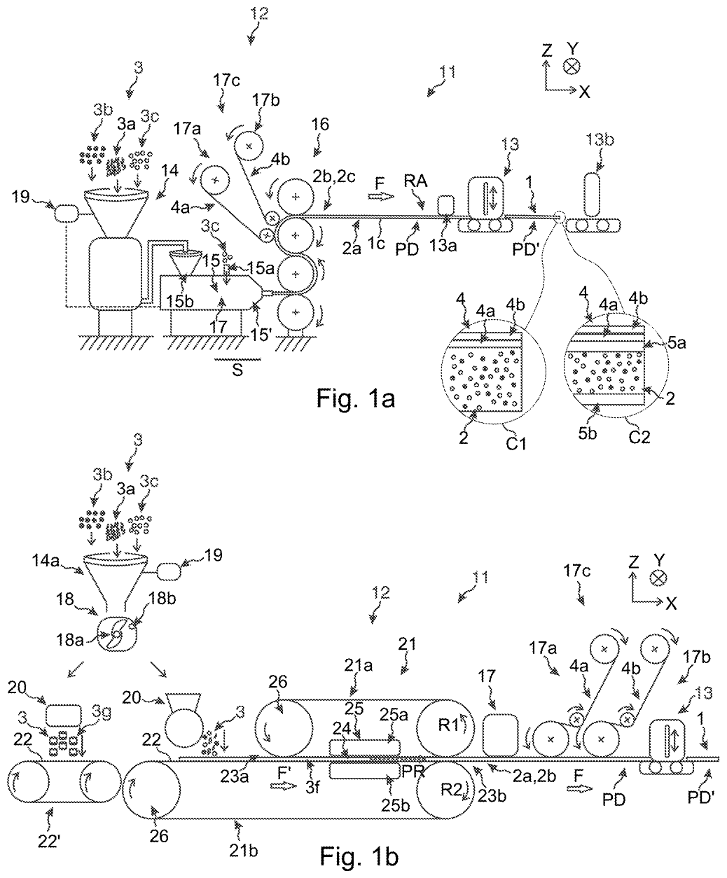

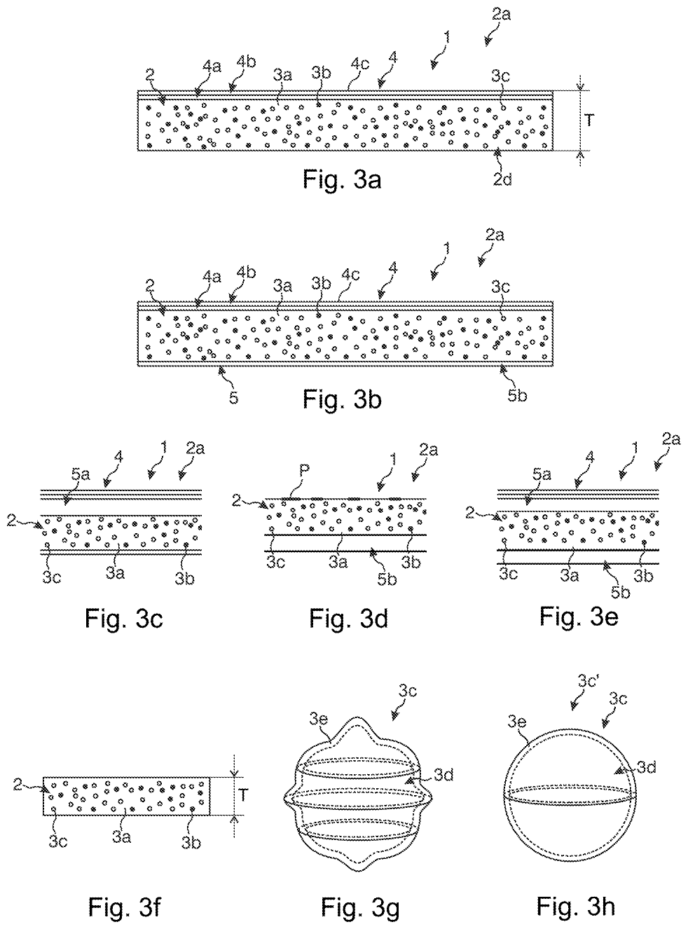

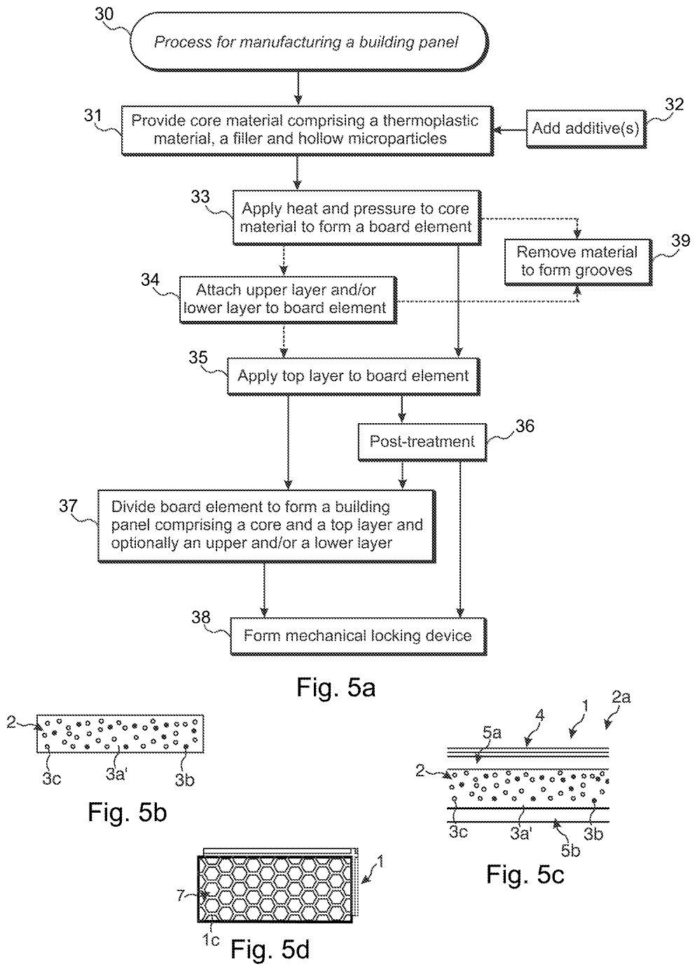

Next, various embodiments of a process for manufacturing of a building panel 1, such as a floor panel, comprising a core 2 will be described with reference to the embodiments in, e.g., FIGS. 1a-1b, 2a-2e and 5a. In some embodiments, and as shown in, e.g., FIGS. 3a-3e, 4a-4f and 5c, the panel 1 to be manufactured may comprise a top layer 4 and optionally a coating layer 4c. In some embodiments, and as shown in, e.g., FIGS. 3f and 5b, a core 2 may be manufactured, which thereby may be a semi-finished product configured to be further processed and/or part of a panel 1. For example, a top layer 4, a coating layer 4c, and optionally an upper 5a and/or a lower 5b layer, may be applied to the core, for example, remote from a location of said manufacturing process.

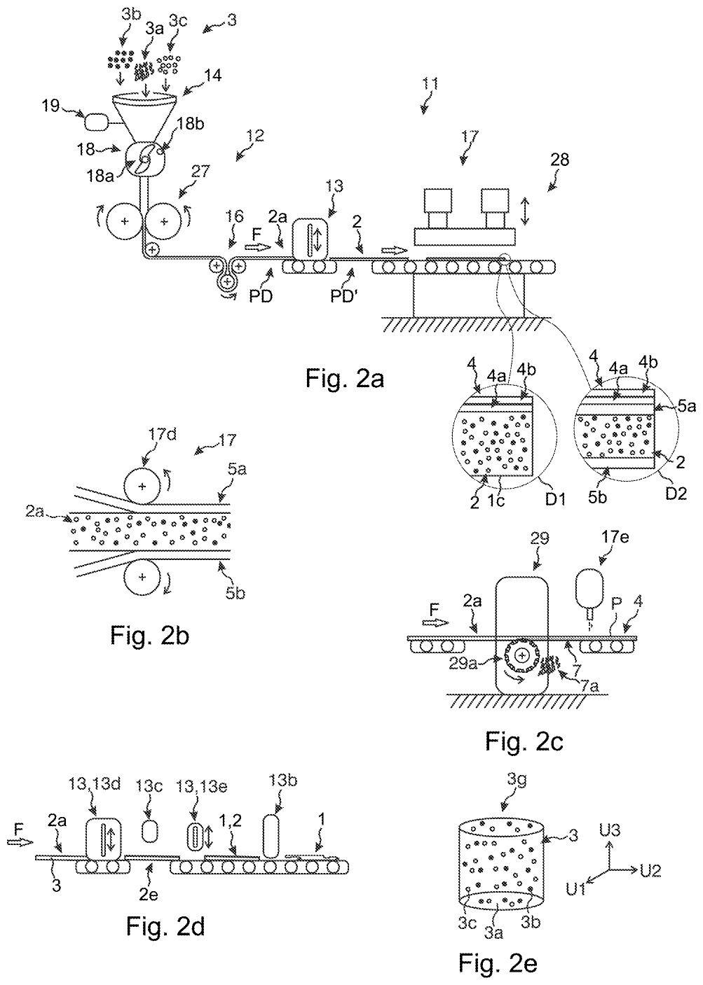

FIGS. 1a-1b and 2a illustrate embodiments of an arrangement 11 capable of implementing the process for manufacturing the panel 1. The arrangement 11 may comprise a board forming device 12 configured to form a board element 2a. The board element 2a may be, or may be dividable into, a core 2, optionally comprising a top layer 4.

Preferably, the board element 2a is formed in a continuous process (FIGS. 1a-1b and 2a) or an intermittent process (FIG. 2a). During manufacturing, the board element 2a may be fed along a feeding direction F of the arrangement 11. The arrangement 11 may extend in a first X and a second Y horizontal direction and in a vertical direction Z. The feeding direction F may be parallel to the first horizontal direction X along at least a portion of the arrangement.

The board forming device 12 may comprise a material container 14 configured to receive core material 3 comprising components in the form of a thermoplastic material 3a and, preferably, a filler 3b and/or hollow microparticles 3c. For example, the material container 14 may be a hopper 14a.

Optionally, the board forming device 12, such as in any of FIGS. 1a-1b, may comprise a top layer roller arrangement 17c comprising a print layer 17a and/or a wear layer 17b roller arrangement. Thereby, a top layer 4, such as print layer 4a and/or a wear layer 4b, may be continuously laminated to the board element 2a after its forming, see the resulting panel 1 in, e.g., the enlarged circles C1 and C2 in FIG. 2a. The top layer may be applied to the board element 2a under pressure from the rollers in the top layer roller arrangement 17c without using an adhesive. Optionally, the board element 2a may be heated during the lamination, such as by IR heat or by means of one or several heated rollers in the top layer roller arrangement 17c. In some embodiments, the top layer 4 may be formed by, preferably digitally, printing a print P directly on the board element 2a or core 2 by a printer 17e and optionally providing a wear layer 4b thereon, cf. FIGS. 2c and 3d.

In some embodiments, and as shown in FIG. 2a, the arrangement 11 may comprise a static press 28, such as a multi-daylight static press. The static press 28 may be a hot-cold press. For example, the press may operate at a pressing temperature of 100-200° C. and/or a pressure of 0.5-2 MPa. Thereby, the top layer 4, such as layer(s) 4a, 4b, may be applied to the board element 2a or core 2 in a discontinuous process, see, e.g., the enlarged circles D1 and D2 in FIG. 2a.

The arrangement 11 may comprise a dividing device 13, for example, comprising knives and/or cutting elements, for dividing the board element 2a into a panel 1, optionally comprising the top layer 4, or a core 2. Dividing may include trimming along the edge portions of the board element 2a being parallel with the feeding direction F.

In some embodiments, and as illustrated in, e.g., FIG. 1a, the board forming device 12 may further comprise an extruder 15 communicating with the material container 14, and a roller arrangement 16 for calendaring an extrudate from the extruder. In non-limiting examples, the roller arrangement 16 may include at least three rolls, such as 4, 5 or 6 rolls. Moreover, the roller arrangement 16 may in some embodiments include an embossing roller. The extrudate may thereby be calendared into a board element 2a in the form of a, preferably continuous, sheet 2b. The sheet 2b may have an essentially constant thickness. A core 2 may be formed from the sheet 2b.

In some embodiments, the extruder 15 in FIG. 1a is a coextruder 15′. The extrudate from the coextruder may thereby be calendared into a board element 2a in the form of a, preferably continuous, sheet assembly 2c. The sheet assembly 2c may have an essentially constant thickness. The sheet assembly 2c may be dividable into a panel 1 comprising a core 2 and an upper 5a and/or lower 5b layer.

A feeding speed of the continuous process configuration comprising the (co-)extruder 15, 15′ and roller arrangement 16 may be 0.5-12 m/min, such as 1-10 m/min or 1.5-9.0 m/min. The barrel temperature of the extruder, preferably when the core material 3 comprises PVC, may be 145-225° C. Alternatively, or additionally, an extrudate temperature directly after forming may be 90-280° C. When the core material 3 comprises PVC, the extrudate temperature may be 90-225° C., preferably 145-220° C.

In some embodiments, and as illustrated in, e.g., FIG. 1b, the board forming device 12 may comprise an application device 20 and a double-belt press 21. The application device 20, preferably provided as a dispenser or a scattering or strewing device, may be configured to apply, preferably dispense, scatter, or strew, the core material 3 on a receiving member 22 of the arrangement 11. As shown in FIG. 1b, the, preferably displaceably arranged, receiving member 22 may be provided as a portion of the double-belt press 21. Alternatively, or additionally, it may be provided as a portion of a, preferably separately arranged, transportation device 22′, such as a conveyor belt, in transportational communication with the press 21.

In some embodiments, the arrangement 11 may comprise a mixer 18 located upstream from the press 21 for mixing the components of the core material 3, e.g., for providing a mixture, which preferably is a dry blend of the materials 3a, 3b, 3c. The mixer 18 may comprise a rotatable mixing member 18a, such as at least one rotor. Thereby, heat may be generated by friction. Optionally, the heat may be controlled, e.g., by a heating mantle. Yet optionally, the mixer 18 may comprise a heater 18b, such as a preheater, for heating and/or at least partially melting the core material 3.

The core material 3 may be transported from the receiving member 22 to a pressing member 25 of the double-belt press. The pressing member 25 may comprise an upper 25a and/or a lower 25b press member configured to apply pressure, and preferably heat, on the core material 3 for forming the board element 2a.

The double-belt press 21 may comprise an upper 21a and a lower 21b endless belt unit configured to continuously revolve in opposite directions R1, R2, preferably by means of a driving mechanism configured to rotate drums 26 of the press 21, e.g., provided at an inlet 23a and outlet 23b thereof. A press gap 24 forming a press path PR may be provided between facing portions of the upper and lower belt units 21a, 21b where portions of the belts therein are displaced along the same direction, preferably along the horizontal direction X. At least a portion of the press path PR may be parallel to a feeding direction F′ of the press 21. The belt units 21a, 21b may feed and guide the core material 3, preferably provided as a mat-shaped layer 3f, along the feeding direction F′ and may apply heat and pressure thereto during the feeding for forming the board element 2a in the form of a, preferably continuous, sheet 2b. The sheet 2b may have an essentially constant thickness.

The upper 25a and lower 25b press members may be provided as a respective portion of the upper 21a and lower 21b belt units, respectively. Preferably, the upper 25a and lower 25b press members are displaceable in a direction perpendicular to the feeding direction F, such as in the vertical direction Z.

As shown in, e.g., FIG. 1b, an extension of the lower belt unit 21b along the feeding direction F, preferably being parallel with the horizontal direction X, may be larger than that of the upper belt unit 21a.

The double-belt press 21 may apply pressure to the core material 3 in an isobaric and/or an isochoric process. The isobaric pressing operation may provide a substantially constant pressure during the pressing operation. Thereby, a more uniform pressure distribution, and hence a more uniform quality, may be provided. The isochoric pressing operation may provide a board element 2a having a constant thickness.

A feeding speed of the continuous process comprising the double-belt press 21 may be 2-m/min. The core material 3, especially when comprising PVC, may be pressed in the double-belt press with a pressure of 0-20 MPa, preferably 0.5-1 MPa, and a temperature of 150-260° C., preferably 200-250° C. The core material may be pressed under heat for at least 0.5 minutes, such as 1-3 minutes.

In some embodiments, and as illustrated in, e.g., FIG. 2a, the board forming device 12 may further comprise a roller mill 27, preferably a two-roller mill, communicating with the material container 14, a mixer 18, such as a Banbury mixer or a kneader, located upstream from the roller mill 27, a heater 18b for heating the core material 3, and a roller arrangement 16 for calendaring the heated material, preferably in the form of a paste, from the roller mill 27. Optionally, the mixer 18 and heater 18b may be combined. In some embodiments, heat may alternatively, or additionally, be provided by friction. In non-limiting examples, the roller arrangement 16 may include at least three rolls, such as 4, 5 or 6 rolls. The heated material may thereby be calendared into a board element 2a in the form of a, preferably continuous, sheet 2b. The sheet 2b may have an essentially constant thickness. The temperature of the heated core material 3, especially when it comprises PVC, may be 90-225° C., preferably 150-190° C.

Preferably, the arrangement 11 comprises an additive reservoir 19 in communication with the material container 14. Alternatively, or additionally, the additive reservoir 19 in FIG. 1a may communicate with the (co-)extruder 15, 15′ (see broken line). Thereby, at least one additive may be added to the core material 3, such as mixture, in FIG. 1a, 1b or 2a.

In some embodiments, and as shown in FIG. 1a, at least a part of the microparticles 3c, such as all of them, may be added to the (co-)extruder 15, 15′ via a feeder 15a. For example, a part of the microparticles 3c, or none of them, may be provided to the material container 14. The feeder 15a may be situated downstream of an inlet 15b of the (co-)extruder, such as in an end portion thereof. Optionally, at least a part of the filler 3b may be added via the feeder 15a or a similar feeder.

Optionally, and as shown in FIGS. 1a-1b and 2a-2b, the arrangement 11 may comprise a layer unit 17 for providing on, or attaching to, such as laminating, the board element 2a an upper 5a and/or a lower 5b layer, preferably under heat and pressure. For example, the layers(s) 5a, 5b may be separately extruded or pressed in a separate pressing device (not shown). In some embodiments, such as in FIG. 1a, the layer(s) 5a, 5b may be provided on the board element or core by being coextruded therewith in the coextruder 15′, which thereby may correspond to the layer unit 17, see, e.g., the resulting panel 1 in the circle C2.

FIG. 2b illustrates an embodiment of the layer unit 17 comprising a roller arrangement 17d, which may be used, e.g., in the embodiments in FIG. 1a (see arrow RA) or 1b. As shown in FIG. 2a, the layer unit 17 may in some embodiments comprise a static press 28, such as a multi-daylight static press. For example, the layer(s) 5a, 5b may be attached to the board element 2a or core 2 together with the top layer 4 in the static press 28, see, e.g., the circle D2 in FIG. 2a.

The upper 5a and/or lower 5b layer(s) disclosed herein, for example, in any of FIGS. 1a-1b, 2a-2b, 3b-3e and 5c, such as in the circles C2 and D2 in FIGS. 1a and 2a, may comprise a thermoplastic material, such as PVC, a filler, additives, and optionally a plasticizer. Preferably, the filler is inorganic, such as a mineral material, for example, CaCO₃, limestone, such as chalk, talc or a stone material, such as stone powder or rock flour. However, an organic filler, such as a wood material, a bamboo material or rice husks, is also equally possible.

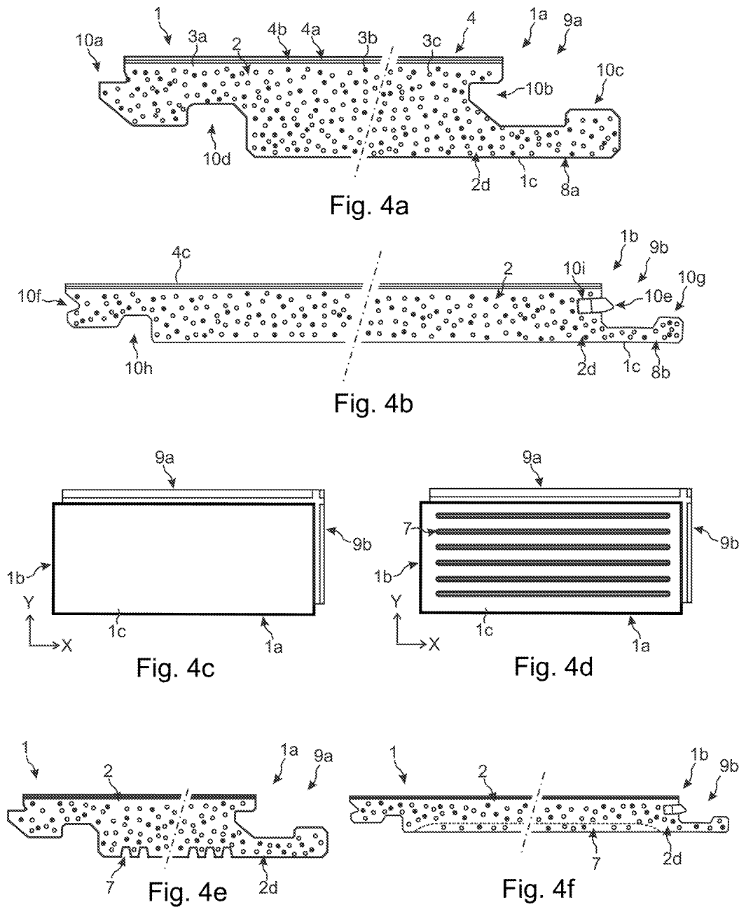

As shown in FIG. 1a, the arrangement 11 may optionally further comprise a coater 13a configured to provide a coating layer 4c on the board element 2a or panel 1, preferably on the top layer 4, such as a UV curable coating layer, a lacquer or a hotmelt coating layer. As also shown in FIGS. 1a and 2d, the arrangement 11 may in some embodiments comprise a profiling unit 13b configured to form a, preferably mechanical, locking device 9a, 9b on a panel 1, cf. FIGS. 4a-4f. An ordinarily skilled artisan will appreciate that the arrangement 11 in, e.g., FIGS. 1b and 2a, may comprise a coater 13a and/or a profiling unit 13b in an analogous manner.

In some embodiments, the arrangement 11 may optionally comprise a processing device 29, such as a rotating cutting device 29a, for forming grooves 7, such as cavities, in the board element 2a or core 2, see FIG. 2c. Such a processing device 29 may be located upstream (see arrow PD) or downstream (see arrow PD′) of the dividing device 13 along the feeding direction F.

The arrangement 11 in, e.g., any of FIGS. 1a-1b and 2a, is capable of implementing a process for manufacturing a panel 1. The flow chart in FIG. 5a illustrates embodiments of such a process (Box 30).

First, a core material 3 comprising a thermoplastic material 3a, such as PVC, a filler 3b, and hollow microparticles 3c, preferably microspheres 3c′, is provided (Box 31). For example, the core material 3 may be provided in the material container 14. A D50 particle size of the filler may be 8-25 μm, preferably 10-20 μm, for example, 14 μm.

Generally herein, such as in FIGS. 1a-1b and 2a, the thermoplastic material 3a, and optionally the entire core material 3, may be provided as a granulate, pellets, a powder, a particulate, chips, or shavings. In non-limiting examples, a size of the powder, optionally being provided as a dry blend of the materials 3a, 3b, 3c, may be 1-250 μm, such as 10-150 μm along one direction, preferably along three perpendicular directions. Moreover, in non-limiting examples, a size of the particulate, chips, or shavings may be between 50 μm and 3 mm along one direction, preferably along three perpendicular directions. For example, the three perpendicular directions may correspond to the directions X, Y, Z when the core material 3 is provided. As shown in, e.g., FIG. 2e, the granulate or pellets 3g may comprise a pre-compounded core material 3. In non-limiting examples, a size of the granulate or pellets 3g may be 0.5-5 mm, such as 1-3 mm, along one direction U1, preferably along three perpendicular directions U1, U2, U3. In any of the examples above, the size may be measured by ISO 13320:2020. In a first example, the filler 3b may be an inorganic filler, such as a mineral material, for example CaCO₃, limestone, such as chalk, talc or a stone material. In a second example, the filler 3b may be an organic filler, such as a wood material, a bamboo material or rice husks. Preferably, a degree of filler 3b in the core 2 does not exceed 70 vol %, preferably being 10-60 vol % or 40-60 vol %, and a degree of microparticles 3c in the core 2 is 3-50 vol %, such as 5-40 vol % or 10-30 vol %.

Embodiments of, preferably non-porous and closed, microparticles 3c having extensions 5-200 μm, such as 10-100 μm, preferably 10-30 μm, are shown in FIGS. 3g-3h. FIGS. 3g and 3h illustrate an irregularly shaped microparticle 3c and a substantially spherical microsphere 3c′, respectively. For example, the microparticles 3c may be microspheres 3c′ comprising a sodalime-borosilicate, such as being a sodalime-borosilicate glass, although other materials are equally conceivable, such as those describe elsewhere herein. An interior of the microparticles 3c may be sealed from an exterior thereof, such as by a particle wall 3e. Optionally, the interior may encapsulate a gas 3d, such as air, nitrogen, or an inert gas. A density of the microparticles may be 100-1000 kg/m³, such as 200-800 kg/m³ or 300-500 kg/m³.

Optionally, at least one additive selected from the group of a stabilizer, a lubricant, an impact modifier, a processing aid and a coupling agent, may be added to the core material 3 from the additive reservoir 19 (Box 32). The additive(s) may be mixed with the core material 3. If the microparticles 3c are polar and the thermoplastic material 3a is nonpolar, a coupling agent may be added. Preferably, a degree of plasticizer in the core material 3 and/or core 2 is less than 5 wt %, preferably less than 3 wt % or less than 1 wt %, and may be in the range of 0.1-5 wt %, 0.5-5 wt %, or 0.5-3 wt %. In some embodiments, there is no plasticizer in the core material and/or core.

The core material 3 in the material container 14 may be fed to the (co-)extruder 15, 15′ (FIG. 1a) or roller mill 27 (FIG. 2a), or scattered or strewed on the receiving member 22 (FIG. 1b), optionally after being mixed in a mixer 18. In some embodiments, a granulate or pellets 3g may alternatively be dispensed by an application device 20 on the receiving member 22 (FIG. 1b).

It is noted that in some embodiments, such as in FIG. 1a, at least a part of the microparticles 3c, such as all of them, may be added to thermoplastic material 3a downstream of the material container 14, for example via the feeder 15a. Optionally, as mentioned above, at least a part of the filler 3b may be added downstream of the material container 14.

Thereafter, heat and pressure are applied to the core material 3 to form a board element 2a (Box 33). The core material 3 in FIG. 1a or 2a may be heated such that it assumes the form of an extrudate and paste, respectively. The extrudate or paste may be calendared in the roller arrangement 16 for forming a sheet 2b (or sheet assembly 2c). The core material 3 in FIG. 1b, preferably provided as a mat-shaped layer 3f when applied on the receiving member 22, may be pressed under heat for forming a sheet 2b.

Preferably, the filler 3b and microparticles 3c are substantially homogeneously distributed in the thermoplastic material 3a, during and/or after forming the board element 2a.

Optionally, an upper 5a and/or a lower 5b layer may be attached, such as laminated, to the board element 2a (Box 34). For example, a lower layer 5b may be a balancing layer 5, cf. FIG. 3b. In some embodiments, such as in any of FIG. 1a, 1b or 2a, the layer(s) 5a, 5b may be provided on, or attached, such as laminated, to, the board element 2a in the layer unit 17. For example, the layer(s) 5a, 5b may be separately formed, such as extruded or pressed under heat, and thereafter attached to the board element. In some embodiments, such as in FIG. 1a, the layer(s) 5a, 5b may be coextruded.

In some embodiments, a top layer 4, such as a print layer 4a and/or a wear layer 4b, may be applied, such as laminated, to the board element 2a (Box 35), preferably by means of the top layer roller arrangement 17c or the static press 28, cf. FIGS. 1a-1b and 2a. In some embodiments, the top layer 4 is formed by digitally printing a print P directly on the board element 2a or core 2 and optionally by applying a wear layer 4b thereon, cf. FIG. 2c. The print layer and/or wear layer in any of the examples above may be provided as a thermoplastic-based foil or film, for example, comprising PVC. For example, a thickness of the print layer and wear layer may be 0.02-0.10 mm and 0.05-1.0 mm, respectively.

Optionally, the board element 2a or panel 1 may be post-treated after its forming (Box 36), such as before or after a dividing of the board element. For example, the coater 13a may provide a coating layer 4c thereon.

Finally, the process may comprise dividing the board element 2a into a, preferably rectangular, building panel 1 (Box 37) by means of the dividing device 13. In a first example, a panel 1 comprising a single layer 2d in the form of a core 2, optionally being provided with the top layer 4, may be provided, see, e.g., FIGS. 3a and 4a-4f. In a second example, a panel 1 comprising a core 2 and an upper 5a and/or lower 5b layer, optionally being provided with the top layer 4, may be provided, see, e.g., FIGS. 3b-3e. Alternatively, when the board element 2a is absent of any top layer 4 and layer(s) 5a, 5b, it may be divided into a core 2, see, e.g., FIG. 3f.

Once a panel 1 has been formed, a, preferably mechanical, locking device 9a, 9b may thereafter optionally be formed on its edge portions using the profiling unit 13b (Box 38), preferably on its long 1a and/or short 1b edge portions, see, e.g., FIGS. 4a-4f and 5d. The locking device may comprise a tongue 10a, 10e and a tongue groove 10b, 10f for vertical locking and/or a locking element 10c, 10g and a locking groove 10d, 10h for horizontal locking. The locking element 10c, 10g may be provided on a strip 8a, 8b extending horizontally beyond an upper portion of the panel 1. For example, the tongue 10a may be integrally formed with the panel along a long edge portion 1a, see, e.g., FIGS. 4a and 4e, while it may be a separately formed tongue 10e provided in an insertion groove 10i along a short edge portion 1b, see, e.g., FIGS. 4b and 4f. The tongue 10e may be flexible and may comprise a polymer-based material, such as a thermoplastic material, e.g., PP, and optionally a reinforcing element, such as glass fibres.

The process may further comprise annealing (or “normalizing”) the board element 2a after its forming for reducing internal stresses therein. For example, as shown in FIG. 2d, an annealing unit 13c may be arranged after a first dividing unit 13d configured to divide the board element 2a into board members 2e and before a second dividing unit 13e configured to divide the board members 2e into at least two cores 2 or panels 1. Thereby, their dimensional stability may increase and/or their balancing properties may become improved. The annealing, especially when the core material 3 comprises PVC, may comprise heating the board element 2a or board member 2e to an annealing temperature of 80-170° C., such as 120-145° C., such as 130-140° C. By way of example, the annealing unit 13c may comprise at least one of a heat oven, a hot-air heater, and a heat bath comprising a fluid, such as water.

At any stage after forming the board element, the process may optionally further comprise the act of forming grooves 7, such as cavities, (Box 39) by removing material 7a from a rear side 1c of the board element 2a or panel 1 by means of the processing device 29. The panels 1 in FIGS. 4d-4f comprise such grooves 7. Alternatively, the grooves 7, such as cavities, may be formed by impressing the rear side 1c, for example as described on page 19, line 26 to page 23, line 22 and FIGS. 1a-1c, 3a-3d, 8a-8b and 9a-9b in the patent application SE 2250776-8, which parts are explicitly incorporated by reference herein. By way of example, and as shown in FIG. 5d, the impressed grooves 7 may form a pattern, such as a honeycomb pattern, as seen from a bottom view of the panel 1.

Generally herein, e.g., in any of FIG. 3a-3f or 4a-4f, a thickness T of the core 2 or panel 1, such as floor panel, may be 2-10 mm, such as 2-5 mm. Moreover, a density of the core 2 and/or panel 1 may be 600-1900 kg/m³, such as 800-1700 kg/m³ or 1000-1500 kg/m³.

Aspects of the disclosure have mainly been described above with reference to a few embodiments. However, as is readily appreciated by a person skilled in the art, other embodiments than the ones disclosed above are equally possible within the scope of the disclosure. For example, it is understood that panels 1 like those in any of the circles C1, C2, D1, D2 may be formed also in a double-belt press 21, e.g., in FIG. 1b. Moreover, the panel described herein may optionally comprise an underlay element provided on its rear side 1c.

It is finally stressed that in some embodiments, such as in any of FIGS. 1b, 2b-2d, 3a-3f, 4a-4f and 5a, the thermoplastic material 3a may be replaced by a thermosetting resin 3a′, preferably comprising polyurethane, PU, an epoxy resin, or a melamine-formaldehyde resin. Two embodiments of such panels are shown explicitly in FIGS. 5b-5c, but the other embodiments described herein for a thermoplastic material 3a, such as those in any of FIGS. 3a-3f and 4a-4f, are equally conceivable for the thermosetting resin 3a′. Preferably, a panel 1 comprising a thermosetting resin 3a′ is manufactured in the process shown in FIG. 1b.

The following examples further describe and demonstrate embodiments within the scope of the present disclosure. The examples are given solely for the purpose of illustration and are not to be construed as limitations of the present disclosure, as many variations thereof are possible without departing from the spirit and scope of the aspects described herein.

### Example 1

Samples S0, S1, . . . , S6 of a board element in the form of a core were produced. Specifically, a respective weighed sample material was mixed and heated using friction and a heat element to 110-130° C. in a hot-cold mixer, whereafter it was cooled to 25-50° C. Thereafter the sample material was compounded in an extruder operating at 170-190° C., and was then cut to produce pellets at a rate of 20 kg/h. The pellets were then pressed in a hot-cold press at a temperature of 140° C. for 840 seconds, and were then cooled to 50° C. during 500 seconds for producing the samples S0, S1, . . . , S6 having a thickness of 5.5-8.0 mm. Each sample comprised chalk (Omyacarb™ 40 GU), 40 vol % PVC and 10 vol % additives comprising a stabilizer, a lubricant, and an impact modifier.

In accordance with Table 1, a reference sample S0 comprised 50 vol % of chalk and no glass bubbles, while the samples S1, . . . , S6 comprised glass bubbles (GB) and a filler in the form of chalk to a degree (vol %). The glass bubbles were closed and non-porous and consisted of sodalime-borosilicate glass. The glass bubbles had a density of 460 kg/m³ and a size of 20 μm, wherein the sizes in the 10^{th} and 90^{th} percentiles were 12 μm and 30 μm, respectively.

The density (p), bending strength (B1) and bending strain (B2) of the samples were then determined. The bending strength and bending strain were measured according to ISO 178:2010. As shown in Table 1, the densities (in kg/m³) of S1, . . . , S6 gradually decreased as the degree of glass bubbles increased. In particular, all the densities were lower than the density of S0. Moreover, the bending strength (in MPa) as well as the bending strain (mm/mm) of S1, . . . , S6 substantially increased as the degree of glass bubbles increased. In particular, all the bending strengths and bending strains were higher than those of S0.

TABLE 1
Sample properties and measuring results

| Sample | Filler | GB | ρ | B1 | B2 | ΔL |
|---|---|---|---|---|---|---|
| S0 | 50 | 0 | 2031 | 23.4 | 0.010 | −0.060 |
| S1 | 40 | 10 | 1950 | 24.0 | 0.014 | −0.070 |
| S2 | 33 | 17 | 1851 | 23.8 | 0.013 | −0.070 |
| S3 | 25 | 25 | 1729 | 281 | 0.025 | −0.060 |
| S4 | 17 | 33 | 1420 | 25.8 | 0.028 | −0.070 |
| S5 | 10 | 40 | 1261 | 27.2 | 0.040 | −0.085 |
| S6 | 0 | 50 | 1024 | 30.6 | 0.055 | −0.065 |

### Example 2

A thermal expansion test was thereafter conducted on each sample S0, S1, . . . , S6. The samples were cut into a size of 180×20 mm and were subjected to a first heat cycle in which they were (1) acclimatized to 23° C., (2) put in a heat oven so that the sample temperatures reached 80° C. after at least 60 minutes, (3) maintained at 80° C. for 45 minutes, (4) cooled to 23° C. during a period of 60 minutes, and (5) maintained at 23° C. for 45 minutes. Thereafter, an initial longitudinal extension L(i) of the samples was measured at a fixed location of the samples, and the samples were subsequently subjected to a second heat cycle identical to the first heat cycle. A final longitudinal extension L(f) was then measured at the fixed locations. It may be seen in Table 1 that the deviation ΔL=L(f)−L(i) (specified in mm) was essentially constant for all the samples, indicating that samples including glass bubbles substantially maintained their climate properties.

### Embodiments

Further aspects of the disclosure are provided below. Embodiments, examples etc. of these aspects are largely analogous to the embodiments, examples, etc., as described above, whereby reference is made to the above for a detailed description.

Item 1. A process for manufacturing a building panel (1), such as a floor panel, comprising a core (2), comprising:
providing a core material (3) comprising a thermoplastic material (3a), a filler (3b) and hollow microparticles (3c);
applying heat and pressure to said core material (3) to form said core (2); and
optionally, applying a top layer (4), such as a print layer (4a) and/or a wear layer (4b), to the core (2).

Item 2. The process according to item 1, wherein the microparticles (3c) encapsulate a gas (3d).

Item 3. The process according to item 1 or 2, wherein the microparticles (3c) are microspheres (3c′), such as hollow glass microspheres.

Item 4. The process according to any of the preceding items, wherein a crushing strength of the microparticles (3c) exceeds 14 MPa, such as being 14-210 MPa or 28-140 MPa.

Item 5. The process according to any of the preceding items, wherein the thermoplastic material (3a) comprises polyvinyl chloride, PVC.

Item 6. The process according to any of the preceding items, wherein the filler (3b) comprises an inorganic filler, such as a mineral material, for example CaCO₃, limestone, such as chalk, talc, or a stone material.

Item 7. The process according to any of the preceding items, wherein the filler (3b) comprises an organic filler, such as a wood material, a bamboo material or rice husks.

Item 8. The process according to any of the preceding items, wherein a degree of filler (3b) in the core (2) does not exceed 70 vol %, preferably being 10-60 vol % or 40-60 vol %.

Item 9. The process according to any of the preceding items, wherein a degree of microparticles (3c) in the core (2) is 3-50 vol %, such as 5-40 vol % or 10-30 vol %.

Item 10. The process according to any of the preceding items, wherein a degree of plasticizer in the core material (3) and/or core (2) is less than 5 wt %, preferably less than 3 wt % or less than 1 wt %.

Item 11. The process according to any of the preceding items, wherein the filler (3b) and microparticles (3c) are substantially homogeneously distributed in the thermoplastic material (3a).

Item 12. The process according to any of the preceding items, further comprising laminating the top layer (4) to the core (2).

Item 13. The process according to any of the preceding items, wherein said applying heat and pressure comprises extruding the core material (3) for forming a sheet (2b).

Item 14. The process according to any of the preceding items, wherein the core (2) is formed in a double-belt press (21).

Item 15. The process according to any of the preceding items, wherein the building panel (1) comprises a single layer (2d) in the form of said core (2), and optionally a top layer (4).

Item 16. The process according to any of the preceding items 1-14, further comprising attaching an upper (5a) and/or a lower (5b) layer, such as a balancing layer (5), to the core (2).

Item 17. The process according to any of the preceding items, further comprising forming at least one groove, such as cavity, (7) by removing material (7a) from a rear side (1c) of said building panel (1) and/or said core (2) or by impressing the rear side (1c).

Item 18. The process according to any of the preceding items, comprising dividing a board element (2a) formed from the application of heat and pressure to the core material (3) into said building panel (1) or said core (2).

Item 19. A building panel (1) obtainable by the process according to any of the preceding items 1-18.

Item 20. A building panel (1) comprising:
a core (2) comprising a thermoplastic material (3a), a filler (3b) and hollow microparticles (3c); and
optionally, a top layer (4), such as a print layer (4a) and/or a wear layer (4b), applied to the core (2).

Item 21. The building panel according to item 20, wherein the microparticles (3c) encapsulate a gas (3d).

Item 22. The building panel according to item 20 or 21, wherein the microparticles (3c) are microspheres (3c′), such as hollow glass microspheres.

Item 23. The building panel according to any of the preceding items 20-22, wherein a crushing strength of the microparticles (3c) exceeds 14 MPa, such as being 14-210 MPa or 28-140 MPa.

Item 24. The building panel according to any of the preceding items 20-23, wherein the thermoplastic material (3a) comprises polyvinyl chloride, PVC.

Item 25. The building panel according to any of the preceding items 20-24, wherein the filler (3b) comprises an inorganic filler, such as a mineral material, for example, CaCO₃, limestone, such as chalk, talc or a stone material.

Item 26. The building panel according to any of the preceding items 20-25, wherein the filler (3b) comprises an organic filler, such as a wood material, a bamboo material or rice husks.

Item 27. The building panel according to any of the preceding items 20-26, wherein a degree of filler (3b) in the core (2) does not exceed 70 vol %, preferably being 10-60 vol % or 40-60 vol %.

Item 28. The building panel according to any of the preceding items 20-27, wherein a degree of microparticles (3c) in the core (2) is 3-50 vol %, such as 5-40 vol % or 10-30 vol %.

Item 29. The building panel according to any of the preceding items 20-28, wherein a degree of plasticizer in the core (2) is less than 5 wt %, preferably less than 3 wt % or less than 1 wt %.

Item 30. The building panel according to any of the preceding items 20-29, wherein the filler (3b) and microparticles (3c) are substantially homogeneously distributed in the core (2).

Item 31. The building panel according to any of the preceding items 20-30, wherein the top layer (4) is laminated to the core (2).

Item 32. The building panel according to any of the preceding items 20-31, wherein the core (2) is formed by extrusion.

Item 33. The building panel according to any of the preceding items 20-32, comprising a single layer (2d) in the form of said core (2), and optionally a top layer (4).

Item 34. The building panel according to any of the preceding items 20-32, further comprising an upper (5a) and/or a lower (5b) layer, such as a balancing layer (5), attached to the core (2).

Item 35. The building panel according to any of the preceding items 20-34, wherein a rear side (1c) of the building panel comprises at least one groove, such as cavity (7).

Item 36. The building panel according to any of the preceding items 20-35, further comprising a mechanical locking device (9a; 9b).

Item 37. The building panel according to any of the preceding items 20-36, wherein the building panel (1) is a floor panel or a wall panel.

Item 38. A process for manufacturing a building panel (1), such as a floor panel, comprising a core (2), comprising:
providing a core material (3) comprising a thermosetting resin (3a′), a filler (3b) and hollow microparticles (3c);
applying heat and pressure to said core material (3) to form said core (2); and
optionally, applying a top layer (4), such as a print layer (4a) and/or a wear layer (4b), to the core (2).

Item 39. The process according to item 38, wherein the thermosetting resin (3a′) comprises PU, an epoxy resin, or a melamine-formaldehyde resin.

Item 40. The process according to item 38 or 39, and further according to any of the items 2-4, 6-10, 12 and 14-18.

Item 41. A building panel (1) comprising:
a core (2) comprising a thermosetting resin (3a′), a filler (3b) and hollow microparticles (3c); and
optionally, a top layer (4), such as a print layer (4a) and/or a wear layer (4b), applied to the core (2).

Item 42. The building panel according to item 41, wherein the thermosetting resin (3a′) comprises PU, an epoxy resin, or a melamine-formaldehyde resin.

Item 43. The building panel according to item 41 or 42, and further according to any of the items 21-23, 25-31 and 33-37.

1. A process for manufacturing a building panel, comprising a core, comprising:
providing a core material comprising a thermoplastic material, a filler and hollow microparticles;
applying heat and pressure to said core material to form said core; and
laminating a top layer, to the core,
wherein the filler comprises an inorganic filler,
wherein a degree of microparticles in the core is 3-50 vol %, and
wherein a crushing strength of the microparticles exceeds 14 MPa.

2. The process according to claim 1, wherein the microparticles are microspheres.

3. The process according to claim 1, wherein the crushing strength of the microparticles is 28-140 MPa.

4. The process according to claim 1, wherein the thermoplastic material comprises polyvinyl chloride, PVC.

5. The process according to claim 1, wherein the inorganic filler comprises CaCO₃, limestone, chalk, talc or a stone material.

6. The process according to claim 5, wherein the inorganic filler comprises chalk or a stone material.

7. The process according to claim 1, wherein a degree of filler in the core does not exceed 70 vol %.

8. The process according to claim 1, wherein a degree of microparticles in the core is 5-40 vol %.

9. The process according to claim 1, wherein the thermoplastic material further comprises a plasticizer.

10. The process according to claim 1, wherein a degree of plasticizer in the core material and/or core is less than 5 wt %.

11. The process according to claim 1, wherein the filler and microparticles are substantially homogeneously distributed in the thermoplastic material.

12. The process according to claim 1, wherein said applying heat and pressure comprises extruding the core material for forming a sheet.

13. The process according to claim 1, wherein the core is formed in a double-belt press.

14. The process according to claim 1, wherein the building panel comprises a single layer in the form of said core, and optionally a top layer.

15. The process according to claim 1, further comprising attaching an upper and/or a lower layer to the core.

16. A building panel obtainable by the process according to claim 1.
